(19) United States
(12) Patent Application Publication
(10) Pub. No.: US 2017/0111832 A1
(43) Pub. Date: Apr. 20, 2017

(54) METHOD AND APPARATUS FOR PROCESSING RLC/PDCP ENTITIES AT A USER EQUIPMENT IN A DUAL CONNECTIVITY SYSTEM

(71) Applicant: Alcatel Lucent, Boulogne-Billancourt (FR)

(72) Inventors: Pingping Wen, Shanghai (CN); Chandrika Worrall, Newbury (GB)

(73) Assignee: Alcatel Lucent, Boulogne Billancourt (FR)

(21) Appl. No.: 15/129,496

(22) PCT Filed: Mar. 20, 2015
(86) PCT No.: PCT/IB2015/000531

§ 371 Date: Sep. 27, 2016

(30) Foreign Application Priority Data
Mar. 28, 2014 (CN) 201410124561.2

(51) Int. Cl. H04W 36/02; H04W 76/02; H04L 5/00

(52) U.S. Cl. CPC H04W 36/023; H04L 5/001; H04W 76/026; H04W 76/021

(57) ABSTRACT

An objective of the present invention is to provide a method and apparatus for processing RLC/PDCP entities at a user equipment in a dual connectivity system; when an uplink radio bearer is reconfigured from a first uplink bearer type between a user equipment and a primary and/or secondary base station into a second uplink bearer type between the user equipment and the secondary and/or primary base station, an RLC entity of the user equipment performing first uplink bearer type between a user equipment corresponding processing; the RLC entity transmitting indication information to a corresponding PDCP entity based on the processing; the PDCP entity performing processing based on the indication information, and transmitting PDCP PDU data corresponding to the uplink radio bearer through RLC entity corresponding to the second uplink bearer type. Compared with the prior art, the present invention provides a method of how to process RLC/PDP entities at a user equipment when an uplink radio bearer is reconfigured from one type of uplink radio bearer to another type of uplink radio bearer, particularly when the split radio bearer is reconfigured into an MCG bearer or an SCG bearer.

### FIELD OF THE INVENTION

The present invention relates to the field of communication technologies, and more specifically to a technology of processing RLC/PDCP entities at a user equipment in a dual connectivity system.

### BACKGROUND OF THE INVENTION

With constant development of communication technologies, improved communication systems have been constantly developed on the basis of legacy communication network architecture, so as to be capable of providing more convenient and prompt data communication services to users.

A dual connectivity system is just an improved communication system being proposed. In the dual connectivity system, a user terminal may perform uplink communication and downlink communication simultaneously with two (or more) base stations. Among the two (or more) base stations communicating with a user terminal, there is a primary base station that may manage the communication of the dual connectivity system, while the remaining base stations are secondary base stations.

Currently, there exists a dual connectivity system supporting 1A user plane architecture and a dual connectivity system supporting 3C user plane architecture.

For the 1A user plane architecture, one radio bearer can only perform transmission through one base station, i.e., through a primary base station or a secondary base station; while for a 3C user plane architecture, one radio bearer may perform simultaneous transmission through both of the primary base station and the secondary base station. The current dual connectivity system simultaneously supports two user plane architectures, i.e., simultaneously supporting 1A user plane architecture and 3C user plane architecture; therefore, there are three radio bearer types, i.e., MCG (Master Cell Group) bearer, SCG (Secondary Cell Group) bearer, and split radio bearer. The MCG bearer corresponds a radio bearer that is transmitted only through a primary base station, while SCG bearer corresponds to a radio bearer that is transmitted only through a secondary base station. For these two types of bearers, they only correspond to one PDCP (Packet Data Convergence Protocol) and one RLC (Radio Link Control) entity, respectively. For uplink split radio bearer, the user equipment has a connection to both the primary base station and the secondary base station, and the uplink split radio bearer may perform transmission simultaneously through the primary and secondary base stations, wherein the transmission link for the uplink split radio bearer between the user equipment and the primary base station is an MCG uplink bearer branch, while the transmission link for the uplink split radio bearer between the user equipment and the secondary base station is an SCG uplink bearer branch.

For a split radio bearer, the user equipment has a PDCP entity, two RLC entities, and two MAC entities. At the PDCP layer, the PDCP PDU (packet data unit) data is created, and transmitted through the RLC entities corresponding to the MCG bearer branch and the SCG bearer branch, respectively.

In a dual connectivity system, the uplink radio bearer is reconfigured from one type of uplink radio bearer into another type of uplink radio bearer. For example, it is reconfigured from the MCG bearer into the SCG bearer, or reconfigured from the SCG bearer into the MCG bearer, or from the split radio bearer into an MCG bearer or SCG bearer. Then, how to process the RLC entity and PDCP entity in a user equipment? For example, how to process data buffer in the RLC entity? However, currently, no specification has been proposed on how to process RLC/PDCP entities at a user equipment yet.

### SUMMARY OF THE INVENTION

An objective of the present invention is to provide a method and apparatus for processing RLC/PDCP entities at a user equipment in a dual connectivity system.

According to one aspect of the present invention, there is provided a method for processing RLC/PDCP entities at a user equipment in a dual connectivity system, the method comprising steps as follows:

a. when an uplink radio bearer is reconfigured from a first uplink bearer type between a user equipment and a primary and/or secondary base station into a second uplink bearer type between the user equipment and the secondary and/or primary base station, an RLC entity of the user equipment performing corresponding processing;

b. the RLC entity transmitting indication information to a corresponding PDCP entity based on the processing;

c. the PDCP entity performing processing based on the indication information, and transmitting PDCP PDU data corresponding to the uplink radio bearer through RLC entity corresponding to the second uplink bearer type.

According to another aspect of the present invention, there is further provided a user equipment for processing RLC/PFCP entities at a user equipment in a dual connectivity system, wherein the user equipment comprises:

an RLC entity configured to, when an uplink radio bearer is reconfigured from a first uplink bearer type between a user equipment and a primary and/or secondary base station into a second uplink bearer type between the user equipment and the secondary and/or primary base station, perform corresponding processing; and transmit indication information to a corresponding PDCP entity based on the processing;

a PDCP entity configured to perform processing based on the indication information, and transmit PDCP PDU data corresponding to the uplink radio bearer through RLC entity corresponding to the second uplink bearer type.

Compared with the prior art, the present invention provides a method of how to process RLC/PDP entities at a user equipment when an uplink radio bearer is reconfigured from one type of uplink radio bearer to another type of uplink radio bearer, particularly when the split radio bearer is reconfigured into an MCG bearer or an SCG bearer. Through the present invention, when the above situation occurs, it becomes much clearer how the RLC/PDCP entities at the user equipment work; moreover, the present invention effectively supports two user plane architectures and three radio bearer types in a dual connectivity system.

### BRIEF DESCRIPTION OF THE ACCOMPANYING DRAWINGS

Through reading the detailed depiction of the non-limiting embodiments with reference to the following drawings, other features, objectives and advantages of the present invention will become more apparent:

FIG. 1 shows a schematic diagram of an uplink radio bearer being reconfigured as a MCG bearer.

FIG. 2 shows a flow diagram of a method for processing RLC/PDCP entities at a user equipment in a dual connectivity system according to one aspect of the present invention.

FIG. 3 shows a schematic diagram of processing RLC/PDCP entities at a user equipment in a dual connectivity system according to one preferred embodiment of the present invention.

FIG. 4 shows a schematic diagram of processing RLC/PDCP entities at a user equipment in a dual connectivity system according to another preferred embodiment of the present invention.

FIG. 5 shows a schematic diagram of processing RLC/PDCP entities at a user equipment in a dual connectivity system according to a still further preferred embodiment of the present invention.

FIG. 6 shows a schematic diagram of processing RLC/PDCP entities at a user equipment in a dual connectivity system according to another still further preferred embodiment of the present invention.

The same or like reference numerals in the drawings represent the same or corresponding components.

### DETAILED DESCRIPTION OF THE PREFERRED EMBODIMENTS

Hereinafter, the present invention will be described in further detail with reference to the accompanying drawings.

In a traditional single connectivity system, one radio bearer can only perform transmission through one base station, so the circumstance of radio bearer type reconfiguration does not exist. Therefore, in a dual connectivity system, when an uplink bearer type is reconfigured as an MCG bearer or an SCG bearer, there is no specification regarding how to process the RLC/PDCP entities at the user equipment. The most similar scenario is a handover scenario of the single connectivity system. However, the two still have the following differences:

1) For a handover scenario, in the target eNB, a security key needs to be reset, and there is a different decryption algorithm. Therefore, for the PDCP PDU (Packet Data Unit) data transmitted back to an RLC layer, they need to be converted into the PDCP SDU data through operations such as header removal and decryption, and then form new PDCP PDU data through encryption by a new algorithm. However, in the dual connectivity system, when the uplink radio bearer type is reconfigured as the MCG bearer, the PDCP corresponding to the MCG bearer needn't be reconfigured, and the PDCP PDU data may be directly transmitted to an RLC entity.

2) for handover, an RLC entity needs to be re-established, and the buffer of the RLC entity needs to be cleared. All data in the PDCP layer are retransmitted to the RLC entity. However, in the dual connectivity system, when the uplink radio bearer is reconfigured from the split radio bearer into the MCG bearer, the RLC entity corresponding to the MCG bearer branch of the split radio bearer has buffered data. Therefore, it needs to be considered based on the actual conditions regarding how to process the RLC entity, i.e., whether to reset the RLC entity, how to process the data buffered in the RLC entity, i.e., transmitting them back to the PDCP layer, or retaining them in the RLC entity.

3) In the traditional system, both uplink and downlink are connected to a same base station. During the handover process, the uplink and downlink are synchronously released and established. Therefore, all RLC entities corresponding to the source base station need to be re-established. However, in the dual connectivity system, the uplink and downlink may be connected to different base stations, respectively. Therefore, it likely occurs that the link in one direction is released, while the link in the other direction is not released. For example, the uplink with the SeNB (Secondary eNB) is released, while the downlink with the SeNB still maintains a connected state.

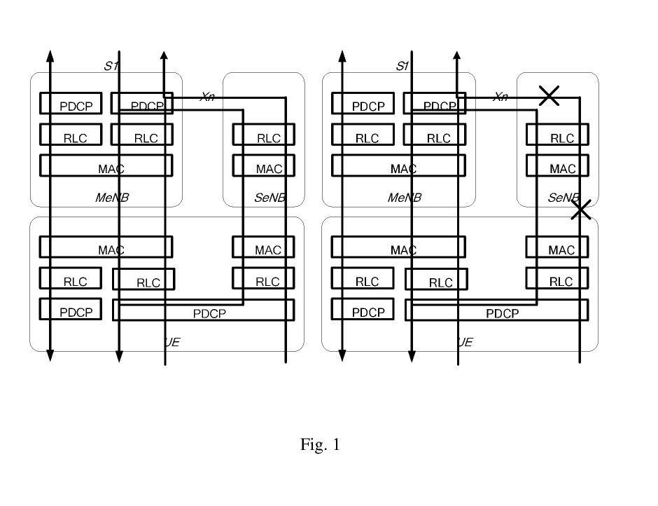

For example, as shown in the left diagram of FIG. 1, both of the uplink radio bearer and the downlink radio bearer support bearer splitting; besides, the uplink radio bearer and the downlink radio bearer are configured with a same logical channel and mapped to the same RLC entity. If an uplink bearer branch performing transmission between the user equipment and the SeNB of the uplink radio bearer is somewhat released, as shown in the right diagram of FIG. 1, the downlink radio bearer mapped to the same RLC entity still keeps performing transmission through the SeNB and the link is not released. Therefore, the RLC entity cannot be re-established. However, in the existing RLC specification (TS 36.322), the PDCP PDU data buffered in the RLC entity are processed only when the RLC entity should be reestablished. Therefore, processing of the RLC entity should be modified to support the dual connectivity system, particularly support the scenario in which the radio bearer type is reconfigured.

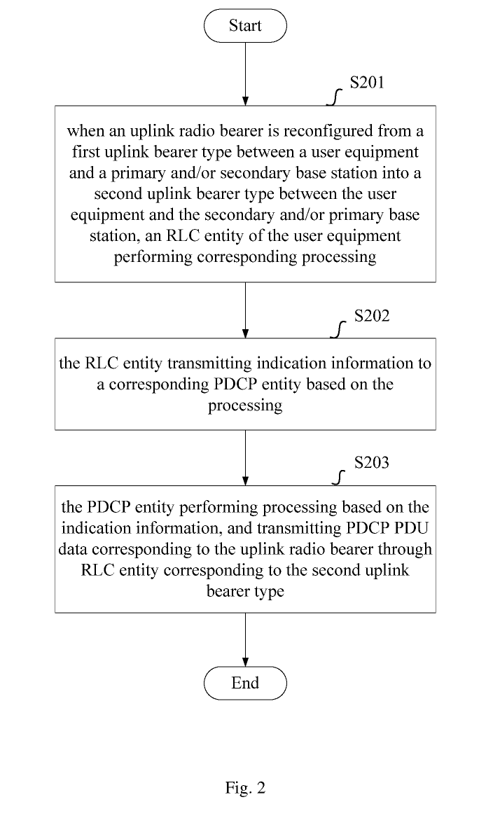

FIG. 2 shows a flow diagram of a method for processing RLC/PDCP entities at a user equipment in a dual connectivity system according to one aspect of the present invention.

In step S201, when an uplink radio bearer is reconfigured from a first uplink bearer type between a user equipment and a primary and/or secondary base station into a second uplink bearer type between the user equipment and the secondary and/or primary base station, an RLC entity of the user equipment performs corresponding processing. Here, processing performed by the RLC entity includes, but not limited to, operations of clearing the RLC entity corresponding to uplink radio bearer, transmitting and retransmitting the data in the buffer. Re-configuration of the uplink bearer type includes:

1) a first uplink bearer type between the user equipment and a primary base station, i.e., MCG uplink bearer, is reconfigured as a second uplink bearer type between the user equipment and a secondary base station, namely, SCG uplink bearer;

2) a first uplink bearer type between the user equipment and the secondary base station, i.e., SCG uplink bearer, is reconfigured as a second uplink bearer type between the user equipment and the primary base station, namely, MCG uplink bearer;

3) a first uplink bearer type between the user equipment and the primary and secondary base stations, i.e., uplink split radio bearer, wherein the uplink split radio bearer is performing transmission simultaneously through the primary and secondary base stations, is reconfigured as a second uplink bearer type between the user equipment and the primary base station, i.e., MCG uplink bearer;

4) a first uplink bearer type between the user equipment and the primary and secondary base stations, i.e., uplink split radio bearer, wherein the uplink split radio bearer is performing transmission simultaneously through the primary and secondary base stations, is reconfigured as a second uplink bearer type between the user equipment and the secondary base station, i.e., SCG uplink bearer.

5) a first uplink bearer type between the user equipment and the primary base station, i.e., MCG uplink bearer, is reconfigured as a second uplink bearer type between the user equipment and the primary and secondary base stations, namely, uplink split radio bearer, wherein the uplink split radio bearer performing transmission simultaneously through the primary and secondary base station.

6) a first uplink bearer type between the user equipment and the secondary base station, namely, SCG uplink bearer, is reconfigured as a second uplink bearer type between the user equipment and the primary and secondary base station, i.e., uplink split radio bearer, wherein the uplink split radio bearer performing transmission simultaneously through the primary and secondary base station.

In step S202, the RLC entity transmits indication information to the corresponding PDCP entity based on the processing. The indication information, for example, includes indication information that indicates PDCP PDU has not been transmitted or has not been acknowledged, e.g., information such as the serial numbers of the PDCP PDU data.

In step S203, the PDCP entity performs processing based on the indication information and transmits the PDCP PDU data corresponding to the uplink radio bearer through the RLC entity corresponding to the second uplink bearer type. For example, when the second uplink bearer type is a MCG uplink bearer, the PDCP entity transmits the PDCP PDU data through an RLC entity corresponding to the MCG uplink bearer. When the second uplink bearer type is an SCG uplink bearer, the PDCP entity transmits the PDCP PDU data through an RLC entity corresponding to the SCG uplink bearer.

Preferably, the first uplink bearer type is uplink split radio bearer, wherein the uplink split radio bearer performs transmission simultaneously through the primary and secondary base stations, wherein the transmission link for the uplink split radio bearer between the user equipment and the primary base station is the MCG uplink bearer branch, the transmission link for the uplink split radio bearer between the user equipment and the secondary base station is the SCG uplink branch.

In one preferred embodiment, the first uplink radio bearer type is the uplink split radio bearer described above. Then, when an uplink radio bearer of the user equipment is reconfigured from the first uplink bearer type into a second uplink bearer type between the user equipment and the primary base station, i.e., the MCG uplink bearer described above. In step S201, the RLC entities of the user equipment corresponding to the MCG uplink bearer branch and the SCG uplink bearer branch, respectively, which corresponding to the uplink split radio bearer, respectively, perform corresponding processing.

In step S202, the RLC entities of the user equipments corresponding to the MCG and SCG uplink bearer branches, respectively, transmit the indication information to the PDCP entity, respectively, based on the processing, wherein the indication information includes serial numbers of PDCP PDU data corresponding to the MCG and SCG uplink bearer branches, respectively. Here, the indication information, for example, includes indication information that indicates PDCP PDUs in the RLC entity which have not been transmitted or acknowledged, e.g., the serial numbers of the PDCP PDU data, and the like.

In step S203, the PDCP entity determines corresponding PDCP PDU data based on the serial numbers, sorts the PDCP PDU data based on the serial numbers and transmits the sorted PDCP PDU data through the RLC entity corresponding to the second uplink bearer type.

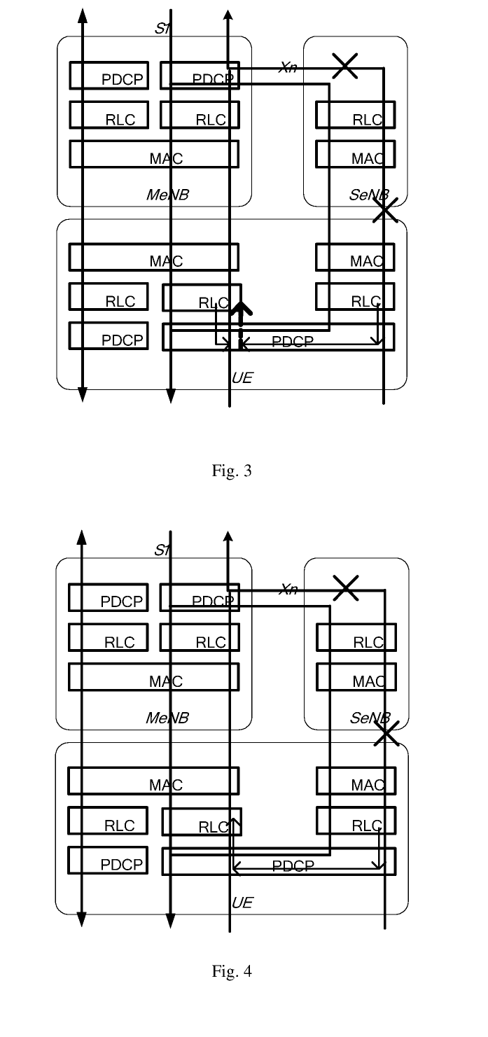

For example, as shown in FIG. 3, the RLC entity corresponding to the MCG uplink bearer branch transmits indication information to the PDCP entity, wherein the indication information includes the serial numbers of the PDCP PDUs which have not been transmitted or acknowledged in the RLC entity corresponding to the MCG uplink bearer branch; the RLC entity corresponding to the SCG uplink bearer branch also transmits the indication information to the PDCP entity, wherein the indication information includes the serial numbers of the PDCP PDUs that have not been transmitted or acknowledged in the RLC entity corresponding to the SCG uplink bearer branch.

The PDCP entity determines corresponding PDCP PDU data based on the serial numbers, and then sorts the PDCP PDU data based on the serial numbers, and transmits the sorted PDCP PDU data through the RLC entity corresponding to the MCG uplink bearer.

In another preferred embodiment, the first uplink bearer type is the uplink split radio bearer as mentioned above. Then, when an uplink radio bearer of the user equipment is reconfigured from the uplink split radio bearer into a second uplink bearer type between the user equipment and the primary base station, i.e., reconfigured into the MCG uplink bearer as mentioned above, in step S201, the RLC entity of the user equipment corresponding to the SCG uplink bearer branch performs corresponding processing.

In step S202, the RLC entity of the user equipment corresponding to the SCG uplink bearer branch transmits the indication information to the PDCP entity based on the processing, wherein the indication information includes serial numbers of the PDCP PDU data corresponding to the SCG uplink bearer branch. Here, the indication information, for example, includes the indication information that indicates PDCP PDUs that have not been transmitted or have not been acknowledged in the RLC entity, e.g., information like serial numbers of the PDCP PDU data.

In step S203, the PDCP entity determines corresponding PDCP PDU data based on the serial numbers, and transmits the PDCP PDU data to the RLC entity corresponding to the second uplink bearer type; the RLC entity corresponding to the second uplink bearer type transmits the PDCP PDU data, as well as the PDCP PDU data in the buffer.

For example, as shown in FIG. 4, the RLC entity corresponding to the SCG uplink bearer branch transmits indication information to the PDCP entity, wherein the indication information includes serial numbers of the PDCP PDU data corresponding to the SCG uplink bearer branch. Here, the PDCP PDU data are PDCP PDU data that have not been transmitted or have not been acknowledged in the RLC entity corresponding to the SCG uplink bearer branch.

The PDCP entity determines corresponding PDCP PDU data based on the serial numbers, and transmits the PDCP PDU data to the RLC entity corresponding to the

MCG uplink bearer; afterwards, the RLC entity corresponding to the MCG uplink bearer transmits the PDCP PDU data together with the PDCP PDU data in its buffer. At the receiving end, these PDCP PDUs are sorted.

In a still further preferred embodiment, the first uplink bearer type is the uplink split radio bearer as mentioned above. Then, when an uplink radio bearer of the user equipment is reconfigured from the uplink split radio bearer into a second uplink bearer type between the user equipment and the secondary base station, i.e., reconfigured as the SCG uplink bearer as mentioned above, in step S201, the RCL entities of the user equipments corresponding to the MCG uplink bearer branch and the SCG uplink bearer branch, respectively, perform corresponding processing.

In step S202, the RLC entities of the user equipments corresponding to the MCG and the SCG uplink bearer, respectively, transmit the indication information to the PDCP entity based on the processing, respectively, wherein the indication information includes serial numbers of the PDCP PDU data corresponding to the MCG and the SCG uplink bearer branches, respectively. Here, the PDCP PDU data are PDCP PDU data that have not been transmitted or acknowledged in the RLC entity corresponding to the SCG uplink bearer branch.

In step S203, the PDCP entity determines corresponding PDCP PDU data based on the serial numbers, and performs decryption and decompression processing to the PDCP PDU data:
resorts the decrypted and decompressed data based on the serial numbers, and performs encryption and compression processing to the resorted data, so as to obtain new PDCP PDU data;
transmits the new PDCP PDU data through the RLC entity corresponding to the second uplink bearer type.

Preferably, the method further comprises step S204 (not shown) and S205 (not shown). In step S204, when an uplink radio bearer is reconfigured from a first uplink bearer type between a user equipment and a primary and/or secondary base station into a second uplink bearer type between the user equipment and the secondary and/or primary base station, the user equipment determines that the MCG uplink bearer branch or the SCG uplink bearer branch corresponding to the first uplink bearer type needs to be released. For example, in the case that the first uplink bearer type is the uplink split radio bearer mentioned above, when the first bearer type is reconfigured as the second uplink bearer type between the user equipment and the primary base station, i.e., the MCG uplink bearer, the user equipment determines that it needs to release the SCG uplink bearer branch. For another example, when the uplink split radio bearer is reconfigured as the second uplink bearer type between the user equipment and the secondary base station, i.e., the SCG uplink bearer, the user equipment determines that it needs to release the MCG uplink bearer branch.

In step S205, the user equipment obtains a status of a downlink bearer that is mapped to the same RLC entity as the released MCG uplink bearer branch or the SCG uplink bearer branch. If the link transmitting the downlink bearer or the downlink bearer is also released, it is needed to establish the RLC entity. Continue the above example. When the user equipment determines a need to release the SCG uplink bearer branch, the status of the downlink bearer that is mapped to the same RLC entity as the released SCG uplink bearer branch is obtained; if the link transmitting the downlink bearer or the downlink bearer is also released, the RCL entity is reestablished. Or, when the user equipment determines a need of releasing the MCG uplink bearer branch, the status of the downlink bearer that is mapped to the same RLC entity as the released MCG uplink bearer is obtained. If the link transmitting the downlink bearer or the downlink bearer is also released, the RLC entity is reestablished.

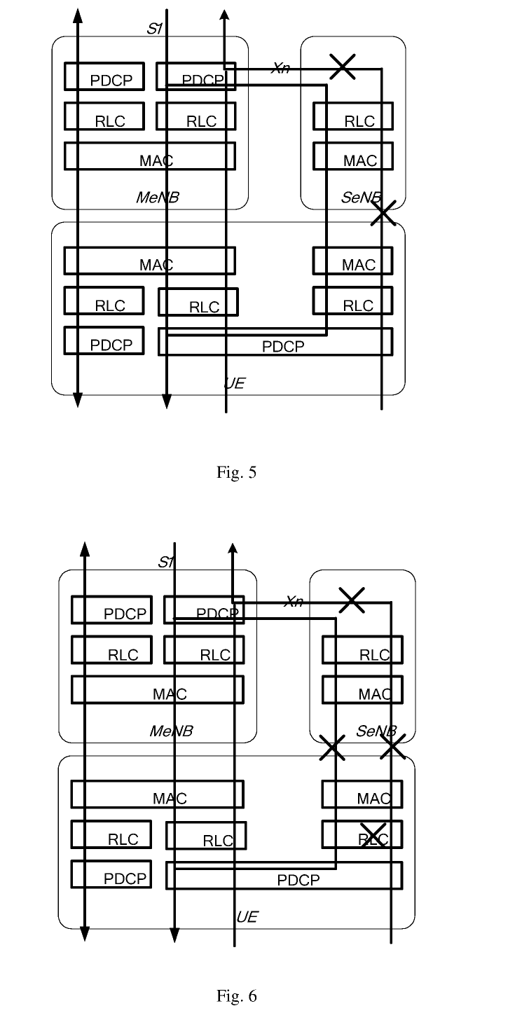

For example, as shown in FIG. 5, the user equipment determines that the SCG uplink bearer branch needs to be released. However, the downlink bearer that is mapped to the same RLC entity as the SCG uplink bearer branch is still in a connected state. Therefore, the RLC entity should be maintained, instead of being reestablished.

For another example, as shown in FIG. 6, the user equipment determines that the SCG uplink bearer branch needs to be released; moreover, the downlink bearer that is mapped to the same RLC entity as the SCG uplink bearer branch is also released. Therefore, the RLC entity should be reestablished.

A user equipment process RLC/PFCP entities at a user equipment in a dual connectivity system, wherein the user equipment comprises an RLC entity and a PDCP entity.

Wherein the RLC entity is configured to, when an uplink radio bearer is reconfigured from a first uplink bearer type between a user equipment and a primary and/or secondary base station into a second uplink bearer type between the user equipment and the secondary and/or primary base station, perform corresponding processing. Here, processing performed by the RLC entity includes, but not limited to, operations of clearing the RLC entity corresponding to uplink radio bearer, transmitting and retransmitting the data in the buffer. Reconfiguration of the uplink bearer type includes:

1) a first uplink bearer type between the user equipment and a primary base station, i.e., MCG uplink bearer, is reconfigured as a second uplink bearer type between the user equipment and a secondary base station, namely, SCG uplink bearer;

2) a first uplink bearer type between the user equipment and the secondary base station, i.e., SCG uplink bearer, is reconfigured as a second uplink bearer type between the user equipment and the primary base station, namely, MCG uplink bearer;

3) a first uplink bearer type between the user equipment and the primary and secondary base stations, i.e., uplink split radio bearer, wherein the uplink split radio bearer is performing transmission simultaneously through the primary and secondary base stations, is reconfigured as a second uplink bearer type between the user equipment and the primary base station, i.e., MCG uplink bearer;

4) a first uplink bearer type between the user equipment and the primary and secondary base stations, i.e., uplink split radio bearer, wherein the uplink split radio bearer is performing transmission simultaneously through the primary and secondary base stations, is reconfigured as a second uplink bearer type between the user equipment and the secondary base station, i.e., SCG uplink bearer.

5) a first uplink bearer type between the user equipment and the primary base station, i.e., MCG uplink bearer, is reconfigured as a second uplink bearer type between the user equipment and the primary and secondary base stations, namely, uplink split radio bearer, wherein the uplink split radio bearer performing transmission simultaneously through the primary and secondary base station.

6) a first uplink bearer type between the user equipment and the secondary base station, namely, SCG uplink bearer, is reconfigured as a second uplink bearer type between the user equipment and the primary and secondary base station, i.e., uplink split radio bearer, wherein the uplink split radio bearer performing transmission simultaneously through the primary and secondary base station.

Then, the RLC entity transmits indication information to the corresponding PDCP entity based on the processing. The indication information, for example, includes indication information that indicates PDCP PDU has not been transmitted or has not been acknowledged, e.g., information such as the serial numbers of the PDCP PDU data.

Afterwards, the PDCP entity performs processing based on the indication information and transmits the PDCP PDU data corresponding to the uplink radio bearer through the RLC entity corresponding to the second uplink bearer type. For example, when the second uplink bearer type is a MCG uplink bearer, the PDCP entity transmits the PDCP PDU data through an RLC entity corresponding to the MCG uplink bearer. When the second uplink bearer type is an SCG uplink bearer, the PDCP entity transmits the PDCP PDU data through an RLC entity corresponding to the SCG uplink bearer.

Preferably, the first uplink bearer type is uplink split radio bearer, wherein the uplink split radio bearer performs transmission simultaneously through the primary and secondary base stations, wherein the transmission link for the uplink split radio bearer between the user equipment and the primary base station is the MCG uplink bearer branch, the transmission link for the uplink split radio bearer between the user equipment and the secondary base station is the SCG uplink branch.

In one preferred embodiment, the first uplink radio bearer type is the uplink split radio bearer described above. The RLC entities in the user equipment comprise RLC entities corresponding to the MCG uplink bearer branch and the SCG uplink bearer branch. Then, when an uplink radio bearer of the user equipment is reconfigured from the first uplink bearer type into a second uplink bearer type between the user equipment and the primary base station, i.e., the MCG uplink bearer described above. The RLC entities of the user equipment corresponding to the MCG uplink bearer branch and the SCG uplink bearer branch, respectively, which corresponding to the uplink split radio bearer, respectively, perform corresponding processing.

Then, the RLC entities of the user equipments corresponding to the MCG and SCG uplink bearer branches, respectively, transmit the indication information to the PDCP entity, respectively, based on the processing, wherein the indication information includes serial numbers of PDCP PDU data corresponding to the MCG and SCG uplink bearer branches, respectively. Here, the indication information, for example, includes indication information that indicates PDCP PDUs in the RLC entity which have not been transmitted or acknowledged, e.g., the serial numbers of the PDCP PDU data, and the like.

Afterwards, the PDCP entity determines corresponding PDCP PDU data based on the serial numbers, sorts the PDCP PDU data based on the serial numbers and transmits the sorted PDCP PDU data through the RLC entity corresponding to the second uplink bearer type.

For example, as shown in FIG. 3, the RLC entity corresponding to the MCG uplink bearer branch transmits indication information to the PDCP entity, wherein the indication information includes the serial numbers of the PDCP PDUs which have not been transmitted or acknowledged in the RLC entity corresponding to the MCG uplink bearer branch; the RLC entity corresponding to the SCG uplink bearer branch also transmits the indication information to the PDCP entity, wherein the indication information includes the serial numbers of the PDCP PDUs that have not been transmitted or acknowledged in the RLC entity corresponding to the SCG uplink bearer branch.

The PDCP entity determines corresponding PDCP PDU data based on the serial numbers, and then sorts the PDCP PDU data based on the serial numbers, and transmits the sorted PDCP PDU data through the RLC entity corresponding to the MCG uplink bearer.

In another preferred embodiment, the first uplink bearer type is the uplink split radio bearer as mentioned above. The RLC entities in the user equipment comprise an RLC entity corresponding to the SCG uplink bearer branch. Then, when an uplink radio bearer of the user equipment is reconfigured from the uplink split radio bearer into a second uplink bearer type between the user equipment and the primary base station, i.e., reconfigured into the MCG uplink bearer as mentioned above, the RLC entity of the user equipment corresponding to the SCG uplink bearer branch performs corresponding processing.

Then, the RLC entity of the user equipment corresponding to the SCG uplink bearer branch transmits the indication information to the PDCP entity based on the processing, wherein the indication information includes serial numbers of the PDCP PDU data corresponding to the SCG uplink bearer branch. Here, the indication information, for example, includes the indication information that indicates PDCP PDUs that have not been transmitted or have not been acknowledged in the RLC entity, e.g., information like serial numbers of the PDCP PDU data.

Afterwards, the PDCP entity determines corresponding PDCP PDU data based on the serial numbers, and transmits the PDCP PDU data to the RLC entity corresponding to the second uplink bearer type; the RLC entity corresponding to the second uplink bearer type transmits the PDCP PDU data, as well as the PDCP PDU data in the buffer.

For example, as shown in FIG. 4, the RLC entity corresponding to the SCG uplink bearer branch transmits indication information to the PDCP entity, wherein the indication information includes serial numbers of the PDCP PDU data corresponding to the SCG uplink bearer branch. Here, the PDCP PDU data are PDCP PDU data that have not been transmitted or have not been acknowledged in the RLC entity corresponding to the SCG uplink bearer branch.

The PDCP entity determines corresponding PDCP PDU data based on the serial numbers, and transmits the PDCP PDU data to the RLC entity corresponding to the MCG uplink bearer; afterwards, the RLC entity corresponding to the MCG uplink bearer transmits the PDCP PDU data together with the PDCP PDU data in its buffer. At the receiving end, these PDCP PDUs are sorted.

In a still further preferred embodiment, the first uplink bearer type is the uplink split radio bearer as mentioned above. The RLC entities in the user equipment comprise RLC entities corresponding to the MCG uplink bearer branch and the SCG uplink bearer branches, respectively. Then, when an uplink radio bearer of the user equipment is reconfigured from the uplink split radio bearer into a second uplink bearer type between the user equipment and the secondary base station, i.e., reconfigured as the SCG uplink bearer as mentioned above, the RCL entities of the user equipments corresponding to the MCG uplink bearer branch and the SCG uplink bearer branch, respectively, perform corresponding processing.

Then, the RLC entities of the user equipments corresponding to the MCG and the SCG uplink bearer, respectively, transmit the indication information to the PDCP entity based on the processing, respectively, wherein the indication information includes serial numbers of the PDCP PDU data corresponding to the MCG and the SCG uplink bearer branches, respectively. Here, the PDCP PDU data are PDCP PDU data that have not been transmitted or acknowledged in the RLC entity corresponding to the SCG uplink bearer branch.

Afterwards, the PDCP entity determines corresponding PDCP PDU data based on the serial numbers, and performs decryption and decompression processing to the PDCP PDU data:
resorts the decrypted and decompressed data based on the serial numbers, and performs encryption and compression processing to the resorted data, so as to obtain new PDCP PDU data;
transmits the new PDCP PDU data through the RLC entity corresponding to the second uplink bearer type.

Preferably, the user equipment further comprises a determining device and a reestablishing device. Wherein the determining device is configured to, when an uplink radio bearer is reconfigured from a first uplink bearer type between a user equipment and a primary and/or secondary base station into a secondary uplink bearer type between the user equipment and the secondary and/or primary base station, determine that the MCG uplink bearer branch or the SCG uplink bearer branch corresponding to the first uplink bearer type needs to be released. For example, in the case that the first uplink bearer type is the uplink split radio bearer mentioned above, when the first bearer type is reconfigured as the second uplink bearer type between the user equipment and the primary base station, i.e., the MCG uplink bearer, the determining device of the user equipment determines that it needs to release the SCG uplink bearer branch. For another example, when the uplink split radio bearer is reconfigured as the second uplink bearer type between the user equipment and the secondary base station, i.e., the SCG uplink bearer, the determining device of the user equipment determines that it needs to release the MCG uplink bearer branch.

The reestablishing device is configured to obtain a status of a downlink bearer that is mapped to a same RLC entity as the released MCG uplink bearer branch or the SCG uplink bearer branch, and if a link transmitting the downlink bearer or the downlink bearer being likewise released, reestablish the RLC entity. Continue the above example. When the determining device of the user equipment determines a need to release the SCG uplink bearer branch, the status of the downlink bearer that is mapped to the same RLC entity as the released SCG uplink bearer branch is obtained; if the link transmitting the downlink bearer or the downlink bearer is also released, the RCL entity is reestablished. Or, when the determining device of the user equipment determines a need of releasing the MCG uplink bearer branch, the status of the downlink bearer that is mapped to the same RLC entity as the released MCG uplink bearer is obtained. If the link transmitting the downlink bearer or the downlink bearer is also released, the RLC entity is reestablished.

For example, as shown in FIG. 5, the determining device of the user equipment determines that the SCG uplink bearer branch needs to be released. However, the downlink bearer that is mapped to the same RLC entity as the SCG uplink bearer branch is still in a connected state. Therefore, the RLC entity should be maintained, instead of being reestablished.

For another example, as shown in FIG. 6, the determining device of the user equipment determines that the SCG uplink bearer branch needs to be released; moreover, the downlink bearer that is mapped to the same RLC entity as the SCG uplink bearer branch is also released. Therefore, the RLC entity should be reestablished.

It should be noted that the present invention may be implemented in software and/or a combination of software and hardware, for example, it may be implemented by an application-specific integrated circuit ASIC, a general purpose computer or any other similar hardware device. In one embodiment, the software program of the present invention may be executed through a processor to implement the steps or functions as mentioned above. Likewise, the software program of the present invention (including relevant data structure) may be stored in the computer-readable recording medium, for example, RAM memory, magnetic or optic driver or flappy disk or similar devices. Besides, some steps or functions of the present invention may be implemented by hardware, for example, as a circuit cooperating with the processor to execute various steps or functions.

Besides, a part of the present invention may be applied as a computer program product, for example, a computer program instruction, which, when executed by a computer, through the operation of the computer, may invoke or provide the method and/or technical solution of the present invention. However, the program instruction invoking the method of the present invention may be stored in a fixed or mobile recording medium, and/or transmitted through a data stream in broadcast or other signal carrier medium, and/or stored in a working memory of a computer device running according to the program instruction. Here, one embodiment according to the present invention comprises an apparatus that includes a memory for storing computer program instructions and a processor for executing program instructions, wherein when the computer program instructions are executed by the processor, the apparatus is triggered to run the methods and/or technical solutions based on the previously mentioned multiple embodiments of the present invention.

To those skilled in the art, it is apparent that the present invention is not limited to the details of above exemplary embodiments, and the present invention can be implemented with other specific embodiments without departing the spirit or basic features of the present invention. Thus, from any perspective, the embodiments should be regarded as illustrative and non-limiting. The scope of the present invention is limited by the appended claims, instead of the above description. Thus, meanings of equivalent elements falling within the claims and all variations within the scope are intended to be included within the present invention. Any reference numerals in the claims should be regarded as limiting the involved claims. Besides, it is apparent that such terms as “comprise” and “include” do not exclude other units or steps, and a single form does not exclude a plural form. The multiple units or modules as stated in apparatus claims can also be implemented by a single unit or module through software or hardware. Terms such as first and second are used to represent names, not representing any specific sequence.

1. A method for processing RLC/PDCP entities at a user equipment in a dual connectivity system, the method comprising:
when an uplink radio bearer is reconfigured from a first uplink bearer type between a user equipment and a primary and/or secondary base station into a second uplink bearer type between the user equipment and the secondary and/or primary base station, an RLC entity of the user equipment performing corresponding processing;
the RLC entity transmitting indication information to a corresponding PDCP entity based on the processing;
the PDCP entity performing processing based on the indication information, and transmitting PDCP PDU data corresponding to the uplink radio bearer through RLC entity corresponding to the second uplink bearer type.

2. The method according to claim 1, wherein the first uplink bearer type is an uplink split radio bearer, wherein the uplink split radio bearer performing transmission simultaneously through the primary and secondary base stations, wherein a transmission link for the uplink split radio bearer between the user equipment and the primary base station is an MCG uplink bearer branch, and a transmission link for the uplink split radio bearer between the user equipment and the secondary base station is an SCG uplink bearer branch.

3. The method according to claim 2, wherein the RLC entity performing corresponding processing further comprises:
when an uplink radio bearer of a user equipment is reconfigured from the first uplink bearer type into a second uplink bearer type between the user equipment and a primary base station, the RLC entities of the user equipments corresponding to the MCG uplink bearer branch and the SCG uplink bearer branch, respectively, performing corresponding processing;
wherein, the RLC entity transmitting comprises:
the RLC entities of the user equipments corresponding to the MCG and SCG uplink bearer branches, respectively, transmitting the indication information to the PDCP entity based on the processing, respectively, wherein the indication information includes serial numbers of PDCP PDU data corresponding to the MCG and SCG uplink bearer branches, respectively;
wherein the PDCP entity performing processing and transmitting step c comprises:
the PDCP entity determining corresponding PDCP PDU data based on the serial numbers, sorting the PDCP PDU data based on the serial numbers, and transmitting the sorted PDCP PDU data through the RLC entity corresponding to the second uplink bearer type.

4. The method according to claim 2, wherein the RLC entity performing corresponding processing comprises:
when an uplink radio bearer of a user equipment is reconfigured from the first uplink bearer type into a second uplink bearer type between the user equipment and the primary base station, an RLC entity of the user equipment corresponding to the SCG uplink bearer branch performing corresponding processing;
wherein the RLC entity transmitting comprises:
the RLC entity of the user equipment corresponding to the SCG uplink bearer branch transmitting the indication information to the PDCP entity based on the processing, wherein the indication information includes serial numbers of PDCP PDU data corresponding to the SCG uplink bearer branch;
wherein the PDCP entity performing processing and transmitting includes:
the PDCP entity determining corresponding PDCP PDU data based on the serial numbers, and transmitting the PDCP PDU data to the RLC entity corresponding to the second uplink bearer type;
the RLC entity corresponding to the second uplink bearer type transmitting the PDCP PDU data, as well as the PDCP PDU data in its buffer.

5. The method according to claim 2, wherein the RLC entity performing corresponding processing comprises:
when an uplink radio bearer of a user equipment is reconfigured from the first uplink bearer type into a second uplink bearer type between the user equipment and the secondary base station, the RLC entities of the user equipments corresponding to the MCG uplink bearer branch and the SCG uplink bearer branch, respectively, performing corresponding processing;
wherein the RLC entity transmitting comprises:
the RLC entities of the user equipments corresponding to the MCG and SCG uplink bearers, respectively, transmitting the indication information to the PDCP entity based on the processing, respectively, wherein the indication information includes serial numbers of PDCP PDU data corresponding to the MCG and SCG uplink bearer branches, respectively;
wherein the PDCP entity performing processing and transmitting comprises:
the PDCP entity determining corresponding PDCP PDU data based on the serial numbers, and performing decryption and decompression processing to the PDCP PDU data;
resorting the decrypted and decompressed data based on the serial numbers, and performing encryption and compression processing to the resorted data, so as to obtain new PDCP PDU data;
transmitting the new PDCP PDU data through the RLC entity corresponding to the second uplink bearer type.

6. The method according to claim 2, wherein the method further comprises:
when an uplink radio bearer is reconfigured from a first uplink bearer type between a user equipment and a primary and/or secondary base station into a secondary uplink bearer type between the user equipment and the secondary and/or primary base station, determining that the MCG uplink bearer branch or the SCG uplink bearer branch corresponding to the first uplink bearer type needs to be released;
obtaining a status of a downlink bearer that is mapped to a same RLC entity as the released MCG uplink bearer branch or the SCG uplink bearer branch, and if a link transmitting the downlink bearer or the downlink bearer being likewise released, reestablishing the RLC entity.

7. A user equipment for processing RLC/PFCP entities at a user equipment in a dual connectivity system, wherein the user equipment comprises:
an RLC entity configured to, when an uplink radio bearer is reconfigured from a first uplink bearer type between a user equipment and a primary and/or secondary base station into a second uplink bearer type between the user equipment and the secondary and/or primary base station, perform corresponding processing; and transmit indication information to a corresponding PDCP entity based on the processing;
a PDCP entity configured to perform processing based on the indication information, and transmit PDCP PDU data corresponding to the uplink radio bearer through RLC entity corresponding to the second uplink bearer type.

8. The user equipment according to claim 7, wherein the first uplink bearer type is an uplink spit radio bearer, wherein the uplink split radio bearer performing transmission simultaneously through the primary and secondary base stations, wherein a transmission link for the uplink split radio bearer between the user equipment and the primary base station is an MCG uplink bearer branch, and a transmission link for the uplink split radio bearer between the user equipment and the secondary base station is an SCG uplink bearer branch.

9. The user equipment according to claim 8, wherein the RLC entities further comprise RLC entities corresponding to the MCG uplink bearer branch and the SCG uplink bearer branch, respectively, configured to:
when an uplink radio bearer of a user equipment is reconfigured from the first uplink bearer type into a second uplink bearer type between the user equipment and a primary base station, perform corresponding processing; transmit the indication information to the PDCP entity based on the processing, respectively, wherein the indication information includes serial numbers of PDCP PDU data corresponding to the MCG and SCG uplink bearer branches, respectively;
wherein, the PDCP entity is configured to:
determine corresponding PDCP PDU data based on the serial numbers, sort the PDCP PDU data based on the serial numbers, and transmit the sorted PDCP PDU data through the RLC entity corresponding to the second uplink bearer type.

10. The user equipment according to claim 8, wherein the RLC entities comprise an RLC entity corresponding to the SCG uplink bearer branch, configured to:
when an uplink radio bearer of a user equipment is reconfigured from the first uplink bearer type into a second uplink bearer type between the user equipment and the primary base station, perform corresponding processing; transmit the indication information to the PDCP entity based on the processing, wherein the indication information includes serial numbers of PDCP PDU data corresponding to the SCG uplink bearer branch;
wherein the PDCP entity is configured to:
determine corresponding PDCP PDU data based on the serial numbers, and transmit the PDCP PDU data to the RLC entity corresponding to the second uplink bearer type;
wherein the RLC entity corresponding to the second uplink bearer type is configured to:
transmit the PDCP PDU, as well as the PDCP PDU data in its buffer.

11. The user equipment according to claim 8, wherein the RLC entities comprise RLC entities corresponding to the MCG uplink bearer branch and the SCG uplink bearer branches, respectively, configured to:
when an uplink radio bearer of a user equipment is reconfigured from the first uplink bearer type into a second uplink bearer type between the user equipment and the secondary base station, perform corresponding processing; and transmit the indication information to the PDCP entity based on the processing, respectively, wherein the indication information includes serial numbers of PDCP PDU data corresponding to the MCG and SCG uplink bearer branches, respectively;
wherein the PDCP entity is configured to:
determine corresponding PDCP PDU data based on the serial numbers, and perform decryption and decompression processing to the PDCP PDU data;
resort the decrypted and decompressed data based on the serial numbers, and perform encryption and compression processing to the resorted data, so as to obtain new PDCP PDU data;
transmit the new PDCP PDU data through the RLC entity corresponding to the second uplink bearer type.

12. The user equipment according to claim 8, wherein the user equipment further comprises:
a determining device configured to, when an uplink radio bearer is reconfigured from a first uplink bearer type between a user equipment and a primary and/or secondary base station into a secondary uplink bearer type between the user equipment and the secondary and/or primary base station, determine that the MCG uplink bearer branch or the SCG uplink bearer branch corresponding to the first uplink bearer type needs to be released;
a reestablishing device configured to obtain a status of a downlink bearer that is mapped to a same RLC entity as the released MCG uplink bearer branch or the SCG uplink bearer branch, and if a link transmitting the downlink bearer or the downlink bearer being likewise released, reestablish the RLC entity.
